(19) United States
(12) Patent Application Publication
(10) Pub. No.: US 2014/0179487 A1
(43) Pub. Date: Jun. 26, 2014

(54) Multiple Speed Transmission With Integrated Low Range

(71) Applicant: FORD GLOBAL TECHNOLOGIES, LLC, Dearborn, MI (US)

(72) Inventors: Steven Gerald Thomas, Bloomfield Hills, MI (US); Donald Edward Hoffman, Canton, MI (US); Gregory Daniel Goleski, Rochester Hills, MI (US)

(73) Assignee: Ford Global Technologies, LLC, Dearborn, MI (US)

(21) Appl. No.: 13/723,983

(22) Filed: Dec. 21, 2012

(51) Int. Cl. F16H 3/62

(52) U.S. Cl. CPC F16H 3/62
USPC 475/275; 475/269

(57) ABSTRACT

A transmission gearing arrangement includes four simple planetary gear sets, three brakes, and four rotating clutches. The brakes and clutches may be engaged in combinations of three to establish at least ten forward transmission ratios and at least three reverse transmission ratios. The lowest forward transmission ratio and lowest reverse transmission ratio may be used to implement a low range mode, obviating the need for a two speed transfer case.

### TECHNICAL FIELD

This disclosure relates to the field of automatic transmissions for motor vehicles. More particularly, the disclosure pertains to an arrangement of gears, clutches, and the interconnections among them in a power transmission.

### BACKGROUND

Many vehicles are used over a wide range of vehicle speeds, including both forward and reverse movement. Some types of engines, however, are capable of operating efficiently only within a narrow range of speeds. Consequently, transmissions capable of efficiently transmitting power at a variety of speed ratios are frequently employed. Typically, a transmission has a housing mounted to the vehicle structure, an input shaft driven by an engine crankshaft, and an output shaft driving the vehicle wheels. A launch device such as a torque converter or launch clutch is often employed between the engine and the transmission input shaft such that the engine can idle while the vehicle and input shaft are stationary. Also, a differential assembly may connect the transmission output shaft to the vehicle wheels, providing an additional fixed speed ratio and permitting the left and right wheel to rotate at slightly different speeds as the vehicle turns. The ratio of transmission input shaft speed to transmission output shaft speed is called the transmission ratio. When the vehicle is at low speed, the transmission is usually operated at a high ratio such that it multiplies the engine torque for improved acceleration. At high vehicle speed, operating the transmission at a low ratio permits an engine speed associated with quiet, fuel efficient cruising.

Some vehicles are equipped with a transfer case which directs the power to both front wheels and rear wheels. Some transfer cases provide multiple transfer case ratios between the transmission output shaft and the differential such that a driver can select a high range and a low range. The high range may be selected for on-road transportation while the low range may be used to provide higher speed ratios for off-road use. When a two speed transfer case is present, the overall ratio is the product of the transmission ratio and the transfer case ratio. In some situations, such as transitioning from on-road to off-road or from off-road to on-road conditions, it is desirable to shift between high and low range while the vehicle is moving, preferably without interrupting the flow of power to the vehicle wheels.

### SUMMARY OF THE DISCLOSURE

A transmission arrangement may include both positive and negative transmission ratios suitable for use in a low range mode of operation.

In one embodiment, a transmission includes input and output shafts and first, second, third, fourth, fifth, and sixth rotating elements. A first gearing arrangement fixedly constrains the speed of the first element to be between the speeds of the input shaft and the second element. The first gearing arrangement may be, for example, a simple planetary gear set having a sun gear fixedly coupled to the input shaft, a carrier as the first element, and a ring gear as the second element. A second gearing arrangement fixedly constrains the speed of the third element to be between the speeds of the first element and the fourth element. The second gearing arrangement may be, for example, a simple planetary gear set having a sun gear as the fourth element, a carrier as the third element, and a ring gear as the first element. A third gearing arrangement fixedly constrains the speeds of the output shaft, third element, fifth element, and sixth element. The third gearing arrangement may be, for example, two simple planetary gear sets wherein the first sun gear is the third element, the second sun gear is the fifth element, the combination of the first carrier and second ring gear is the sixth element, and the first ring gear and second carrier are fixedly coupled to the output shaft. The third gearing arrangement may be, as another example, two simple planetary gear sets wherein the second ring gear is the third element, the combination of the first sun gear and the second sun gear is the fifth element, the combination of the first ring gear and the second carrier is the sixth element, and the first carrier is fixedly coupled to the output shaft. The transmission may include a number of clutches including first, second, and third brakes that selectively hold the fifth element, the fourth element, and the second element, respectively, against rotation. First and second clutches may selectively couple the second element and the sixth element, respectively, to the input shaft. A third clutch may selectively couple the fourth element to the sixth element and a fourth clutch may selectively couple the second element to the third element. When all seven clutches are present, the third brake may be utilized as a range clutch which is engaged to launch a vehicle in low range but is disengaged to launch the vehicle in high range. The range clutch may be re-engaged in either range to establish overdrive ratios.

In another embodiment, a transmission includes a transmission case, input and output shafts, and first, second, third, fourth, fifth, sixth, seventh, and eighth rotating elements. A first gearing arrangement fixedly constrains the speed of the first element to be between the speeds of the input shaft and the second element. A second gearing arrangement fixedly constrains the speed of the third element to be between the speeds of the first element and the fourth element. A third gearing arrangement fixedly constrains the speed of the sixth element to be between the speeds of the output shaft and the third element. A fourth gearing arrangement fixedly constrains the speed of the seventh element to be between the speeds of the fifth element and the eighth element. The fifth element is fixedly or selectively coupled to the transmission case, the seventh element is fixedly or selectively coupled to the output shaft, and the eighth element is fixedly or selectively coupled to the sixth element. In an exemplary embodiment, a first brake selectively couples the fifth element to the transmission case while the seventh element is fixedly coupled to the output shaft and the eighth element is fixedly coupled to the sixth element. Second and third brakes may selectively couple the fourth element and the second element, respectively, to the transmission case. First and second clutches may selectively couple the second element and the sixth element, respectively, to the input shaft. A third clutch may selectively couple the fourth element to the sixth element and a fourth clutch may selectively couple the second element to the third element. When all seven clutches are present, the third brake may be utilized as a range clutch which is engaged to launch a vehicle in low range but is disengaged to launch the vehicle in high range. The range clutch may be re-engaged in either range to establish overdrive ratios.

In another embodiment, a vehicle is launched in reverse using a first negative transmission ratio when high range is selected and is launched in reverse using a second negative transmission ratio when low range is selected. When launched in the second negative ratio, the vehicle may optionally shift to the first negative transmission ratio. When in the first negative transmission ratio, the vehicle may shift to a third negative transmission ratio. The vehicle may also be launched using a first positive transmission ratio when high range is selected and launched in a second positive transmission ratio when low range is selected followed by a shift to the first positive transmission ratio. The shift from the second positive transmission ratio to the first positive transmission ratio may include release a range clutch. The range clutch may be re-engaged to establish a third positive transmission ratio which may be an overdrive ratio.

### BRIEF DESCRIPTION OF THE DRAWINGS

FIG. 1 is a schematic diagram of a first transmission gearing arrangement;

FIG. 2 is a schematic diagram of a second transmission gearing arrangement;

FIG. 3 is a clutch application chart indicating the state of each clutch in the gearing arrangements of FIGS. 1 and 2; and

FIG. 4 is a lever diagram corresponding to the gearing arrangements of FIGS. 1 and 2.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A gearing arrangement is a collection of rotating elements and clutches configured to impose specified speed relationships among elements. Some speed relationships, called fixed speed relationships, are imposed regardless of the state of any clutches. Other speed relationships, called selective speed relationships, are imposed only when particular clutches are fully engaged. A discrete ratio transmission selectively imposes a variety of speed ratios, called transmission ratios, between an input shaft and an output shaft.

Certain rotating elements can be coupled to one another, and that coupling can be fixedly coupled or selectively coupled. A group of elements are fixedly coupled to one another if they are constrained to rotate as a unit in all operating conditions. Elements may be fixedly coupled by spline connections, welding, press fitting, machining from a common solid, or other means. Slight variations in rotational displacement between fixedly coupled elements can occur such as displacement due to spline lash or shaft compliance. In contrast, two elements are selectively coupled by a clutch when the clutch constrains them to rotate as a unit whenever the clutch is fully engaged and they are free to rotate at distinct speeds in at least some other operating condition. Clutches include actively controlled devices such as hydraulically or electrically actuated clutches and passive devices such as one way clutches. A clutch that holds an element against rotation by selectively connecting the element to the housing may be called a brake.

Shifts among speed ratios may be performed without interrupting the flow of power from the input shaft to the output shaft by carefully coordinating the engagement of one clutch with the disengagement of another clutch. During the transition, one or both of these clutches must transmit torque between elements moving at different speeds. In such a condition, heat is absorbed and dissipated by the clutch. The amount of energy absorbed is larger when the ratio of the two speed ratios involved, called the step size, is higher. Sometimes, providing a clutch with enough energy absorption capability dictates the sizing of the clutch and increases the amount of parasitic drag the clutch causes when disengaged. Also, shifts with very large step sizes are difficult to perform without generating large torque disturbances at the output shaft which may be uncomfortable for vehicle occupants.

Typical two speed transfer cases have step sizes exceeding 2:1. In order to minimize the parasitic drag associated with the transfer case, the transfer case is often configured such that shifting between the low range and high range is only possible when the vehicle is stationary. If range shifts are allowed while the vehicle is moving, it may be necessary to interrupt the flow of power by putting the transmission in neutral while shifting the transfer case.

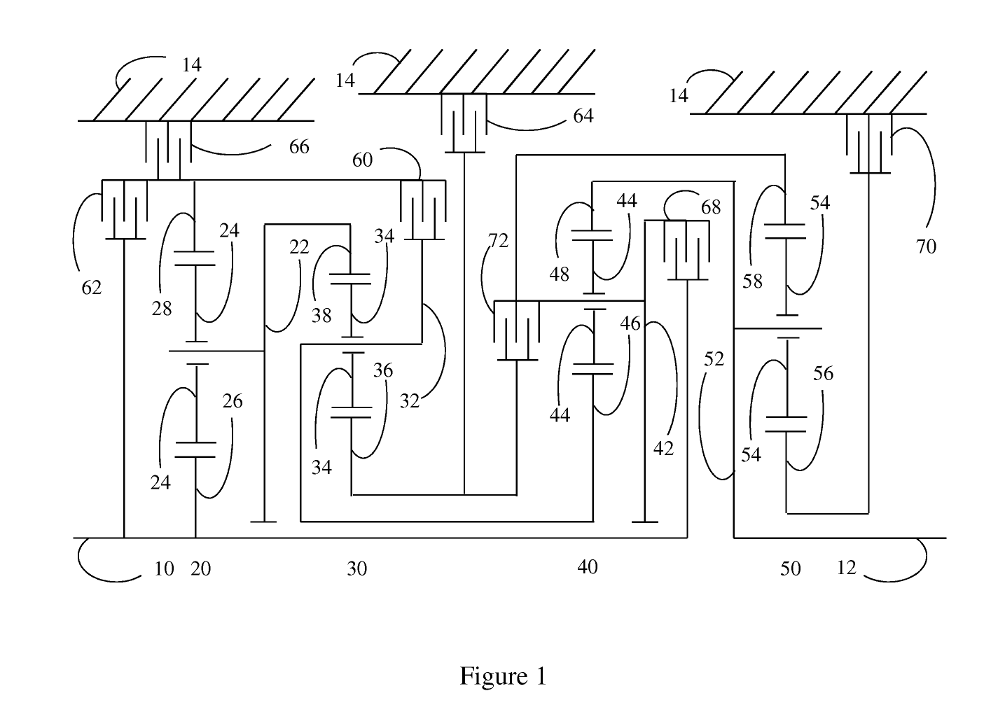

An example transmission is schematically illustrated in FIG. 1. The transmission utilizes four simple planetary gear sets 20, 30, 40, and 50. A simple planetary gear set is a type of gearing arrangement. A planet carrier 22 rotates about a central axis and supports a set of planet gears 24 such that the planet gears rotate with respect to the planet carrier. External gear teeth on the planet gears mesh with external gear teeth on a sun gear 26 and with internal gear teeth on a ring gear 28. The sun gear and ring gear are supported to rotate about the same axis as the carrier. A simple planetary gear set imposes the fixed speed relationship that the speed of the carrier is between the speed of the sun gear and the speed of the ring gear. (This relationship is defined to include the condition in which all three rotate at the same speed.) More specifically, the speed of the carrier is a weighted average of the speed of the sun gear and the speed of the ring gear with weighting factors determined by the number of teeth on each gear. Similar speed relationships are imposed by other known types of fixed gearing arrangements. For example, a double pinion planetary gear set constrains the speed of the ring gear to be a weighted average between the speed of the sun gear and the speed of the carrier. A suggested ratio of gear teeth for each planetary gear set in FIG. 1 is listed in Table 1.

TABLE 1

| | |
|---|---|
| Ring 28/Sun 26 | 1.750 |
| Ring 38/Sun 36 | 2.200 |
| Ring 48/Sun 46 | 1.480 |
| Ring 58/Sun 56 | 2.700 |

Input shaft 10 is fixedly coupled to sun gear 26. Output shaft 12 is fixedly coupled to ring gear 48 and carrier 52. Carrier 22 is fixedly coupled to ring gear 38, carrier 32 is fixedly coupled to sun gear 46, and carrier 42 is fixedly coupled to ring gear 58. Input shaft 10 is selectively coupled to ring gear 28 by clutch 62 and selectively coupled to carrier 42 by clutch 68. Note that engaging clutch 62 has the effect of forcing all of the components of planetary gear set 20 to rotate as a unit. This effect can alternatively be achieved by a clutch that selectively couples carrier 22 to either sun gear 26 or ring gear 28. Ring gear 28 is selectively coupled to the combination of carrier 32 and sun gear 46 by clutch 60 and selectively held against rotation by brake 66. Sun gear 36 is selectively coupled to the combination of carrier 42 and ring gear 58 by clutch 72 and selectively held against rotation by brake 64. Finally, sun gear 56 is selectively held against rotation by brake 70.

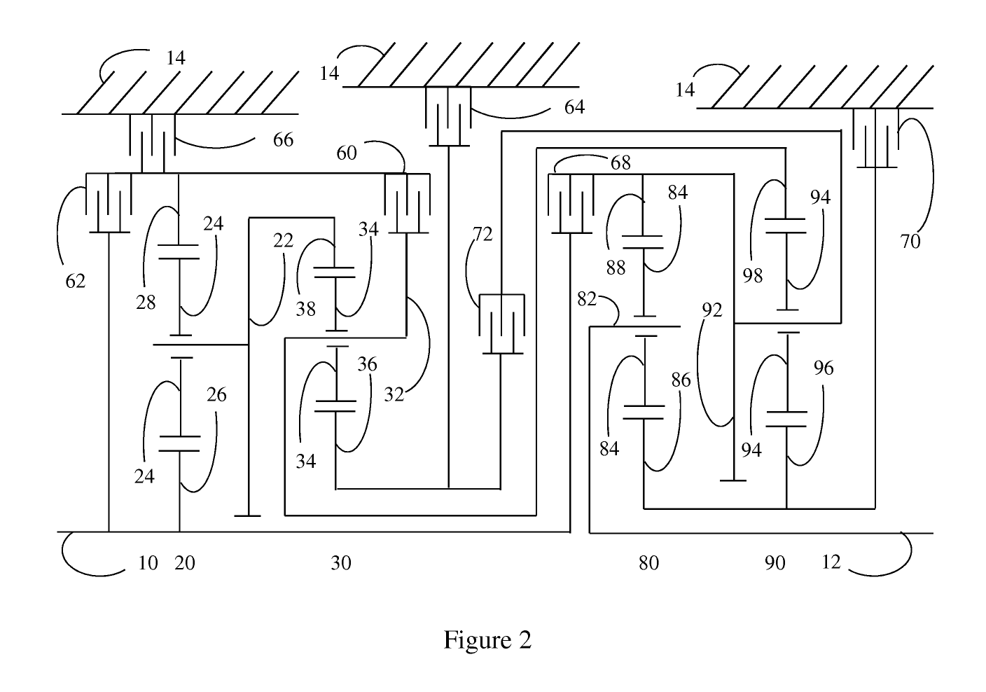

Another example transmission is illustrated in FIG. 2. Input shaft 10 is fixedly coupled to sun gear 26. Output shaft 12 is fixedly coupled to carrier 82. Carrier 22 is fixedly coupled to ring gear 38, carrier 32 is fixedly coupled to ring gear 98, and ring gear 88 is fixedly coupled to carrier 92. Input shaft 10 is selectively coupled to ring gear 28 by clutch 62 and selectively coupled to the combination of ring gear 88 and carrier 92 by clutch 68. Ring gear 28 is selectively coupled to the combination of carrier 32 and ring gear 98 by clutch 60 and selectively held against rotation by brake 66. Sun gear 36 is selectively coupled to the combination of ring gear 88 and carrier 92 by clutch 72 and selectively held against rotation by brake 64. Finally, sun gears 86 and 96 are selectively held against rotation by brake 70. A suggested ratio of gear teeth for each planetary gear set in FIG. 2 is listed in Table 2.

TABLE 2

| | |
|---|---|
| Ring 28/Sun 26 | 1.750 |
| Ring 38/Sun 36 | 2.200 |
| Ring 88/Sun 86 | 2.500 |
| Ring 98/Sun 96 | 2.700 |

The clutches and brakes may be hydraulically actuated multi-plate clutches or other types of clutches that are actively engaged and disengaged by a controller. Brake 66 may be a combination of a controllable clutch and a passive one way clutch each selectively coupling ring gear 28 to transmission case 14. Such a combination may be engaged either actively by the controller or as a result of the one way clutch resisting rotation of ring gear 28 in a reverse direction. Such a combination may be desirable to improve shift quality and to reduce parasitic losses because the actively controlled portion is not called upon to transmit as much torque.

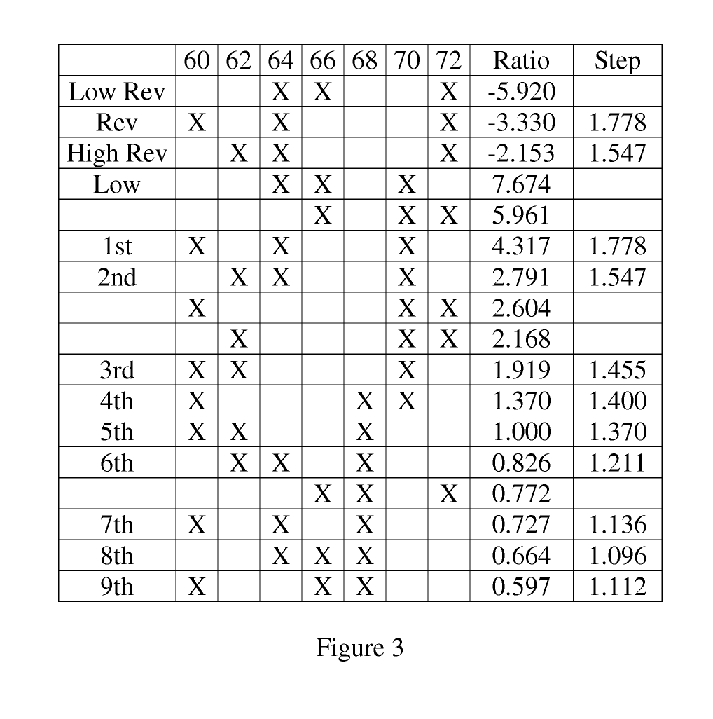

As shown in FIGS. 3, engaging the clutches in combinations of three establishes a variety of forward and reverse speed ratios between input shaft 10 and output shaft 12. An X indicates that the clutch is engaged to establish the speed ratio. The transmission provides for both high and low range operation without a two speed transfer case. When the driver selects drive (forward) and high range, the transmission is prepared for vehicle launch in 1st by engaging clutch 60 and brakes 64 and 70. A shift to 2nd may be accomplished by gradually disengaging clutch 60 while gradually engaging clutch 62. A shift to 3rd may be accomplished by gradually disengaging brake 64 while gradually re-engaging clutch 60. As shown in FIG. 3, two transmission ratios between 2nd and 3rd are available with alternative combinations of engaged clutches. These additional ratios may be utilized in some circumstances. A shift from 3rd to 4th may be accomplished by gradually disengaging clutch 62 while gradually engaging clutch 68. A shift to 5th may be accomplished by gradually disengaging brake 70 while gradually re-engaging clutch 62. A shift to 6th may be accomplished by gradually disengaging clutch 60 while gradually re-engaging brake 64. A shift to 7th may be accomplished by gradually disengaging clutch 62 while gradually re-engaging clutch 60. As shown in FIG. 3, an additional transmission ratio between 6th and 7th may be utilized in some circumstances. A shift from 7th to 8th may be accomplished by gradually disengaging clutch 60 while gradually engaging brake 66. Finally, a shift to 9th may be accomplished by gradually disengaging brake 64 while gradually re-engaging clutch 60. The 6th, 7th, 8th, and 9th transmission ratios are all overdrive ratios in which the output shaft rotates faster than the input shaft.

When the driver selects drive (forward) and low range, the transmission is prepared for vehicle launch by engaging brakes 64, 66, and 70. If brake 66 is implemented as a combination of a passive one way clutch and an actively controlled clutch, then the transmission would transmit power from the engine to the wheels without active engagement. However, if transmission of power in the opposite direction is desired, such as for engine braking, then brake 66 must be actively controlled. A shift to 1st may be accomplished by gradually disengaging brake 66 while gradually engaging clutch 60. If the brake 66 includes a one way clutch, the one way clutch will disengage passively as clutch 60 is engaged, eliminating the need to actively control the disengagement. Additional shifts into the remaining forward ratios may be accomplished as described above for high range. As shown in FIG. 3, an additional transmission ratio between low and 1st may be utilized, if desired, to perform this shift in two steps.

When the driver selects reverse and high range, the transmission is prepared for reverse launch by engaging clutches 60 and 72 and brake 64. Optionally, a shift to a higher reverse ratio may be accomplished by gradually disengaging clutch 60 while gradually engaging clutch 62. When the driver selects reverse and low range, the transmission is prepared for reverse launch by engaging clutch 72 and brakes 64 and 66. Optionally, a shift into the high range reverse ratio may be accomplished as described above for the low to 1st shift.

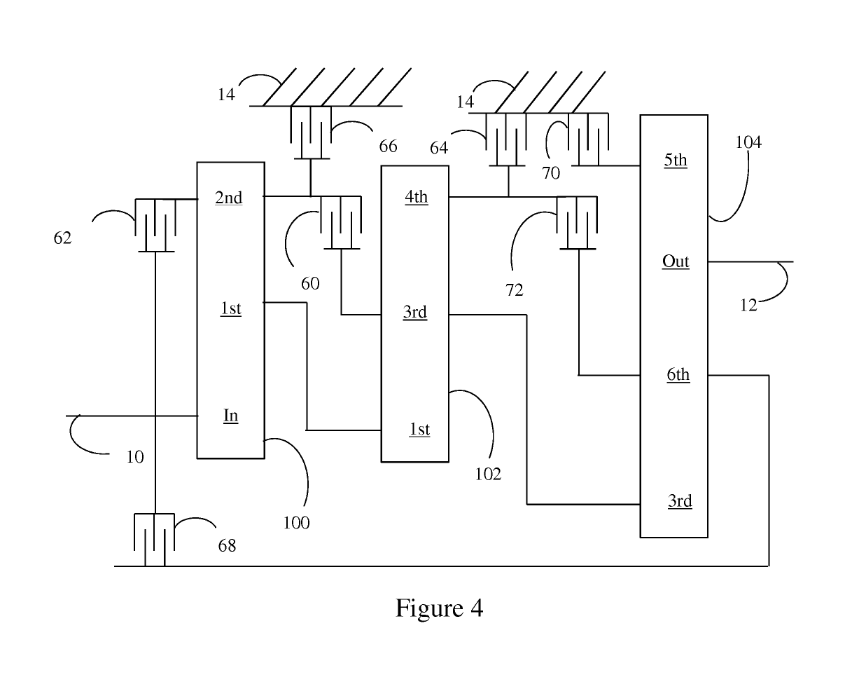

FIG. 4 describes the transmissions of FIGS. 1 and 2 in the form of a lever diagram. Gear elements which rotate about a common axis and have speeds with a fixed linear relationship are shown along a lever according to their relative speeds. The two elements that have the most extreme speeds are shown at the endpoints of the lever. The remaining elements are shown at intermediate points. The 1st through 6th rotating elements each correspond to one or more planetary gear elements. Gear sets 20 and 30 correspond directly to three node levers 100 and 102 with the sun gear at one endpoint, the ring gear at the opposite endpoint, and the carrier at an intermediate point. Specifically, the 1st element corresponds to carrier 22 and ring gear 38, the 2nd element corresponds to ring gear 28, the 3rd element corresponds to carrier 32, and the 4th element corresponds to sun gear 36. Four node lever 104 corresponds to gear sets 40 and 50 of FIG. 1, with the 3rd element corresponding to sun gear 46, the 5th element corresponding to sun gear 56, and the 6th element corresponding to carrier 42 and ring gear 58. Four node lever 104 also corresponds to gear sets 80 and 90 of FIG. 2, with the 3rd element corresponding to ring gear 98, the 5th element corresponding to sun gear 86 and sun gear 96, and the 6th element corresponding to carrier 92 and ring gear 88. Any four element gearing arrangement that imposes the designated fixed speed relationships with appropriate weighting factors may be substituted for gear sets 40 and 50 of FIG. 1 or gear set 80 and 90 of FIG. 2 without impacting the transmission speed ratios. Any combination of two planetary gear sets with two elements of each fixedly connected to two elements of the other forms a four element fixed gearing arrangement. Some fixed gearing arrangements will be preferable to others in terms of packaging, efficiency, and planet gear speeds.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A transmission comprising:
an input shaft;
an output shaft;
a first gearing arrangement configured to fixedly constrain a first element to rotate at a speed between speeds of the input shaft and a second element;
a second gearing arrangement configured to fixedly constrain a third element to rotate at a speed between speeds of the first element and a fourth element; and
a third gearing arrangement configured to fixedly constrain the output shaft to rotate at a speed between speeds of a fifth element and a sixth element and to fixedly constrain the sixth element to rotate at a speed between speeds of the output shaft and the third element.

2. The transmission of claim 1 further comprising:
a first brake configured to selectively hold the fifth element against rotation;
a second brake configured to selectively hold the fourth element against rotation;
a first clutch configured to selectively operatively couple the input shaft to the second element;
a second clutch configured to selectively couple the input shaft to the sixth element; and
a third clutch configured to selectively couple the fourth element to the sixth element.

3. The transmission of claim 2 wherein the second element is coupled to the third element.

4. The transmission of claim 3 further comprising a fourth clutch configured to selectively couple the second element to the third element.

5. The transmission of claim 4 further comprising a third brake configured to selectively hold the second element against rotation.

6. The transmission of claim 3 further comprising a third brake configured to selectively hold the second element against rotation.

7. The transmission of claim 1 wherein the first gearing arrangement comprises a simple planetary gear set having a sun gear fixedly coupled to the input shaft, a planet carrier as the first element, a ring gear as the second element, and a plurality of planet gears supported for rotation relative to the planet carrier and in continuous meshing engagement with both the sun gear and the ring gear.

8. The transmission of claim 1 wherein the second gearing arrangement comprises a simple planetary gear set having a sun gear as the fourth element, a planet carrier as the third element, a ring gear as the first element, and a plurality of planet gears supported for rotation relative to the planet carrier and in continuous meshing engagement with both the sun gear and the ring gear.

9. The transmission of claim 1 wherein the third gearing arrangement comprises:
a first simple planetary gear set having a first sun gear as the third element, a first planet carrier as the sixth element, a first ring gear fixedly coupled to the output shaft, and a first plurality of planet gears supported for rotation relative to the first planet carrier and in continuous meshing engagement with both the first sun gear and the first ring gear; and
a second simple planetary gear set having a second sun gear as the fifth element, a second planet carrier fixedly coupled to the output shaft, a second ring gear fixedly coupled to the first planet carrier, and a second plurality of planet gears supported for rotation relative to the second planet carrier and in continuous meshing engagement with both the second sun gear and the second ring gear.

10. The transmission of claim 1 wherein the third gearing arrangement comprises:
a first simple planetary gear set having a first sun gear as the fifth element, a first planet carrier fixedly coupled to the output shaft, a first ring gear as the sixth element, and a first plurality of planet gears supported for rotation relative to the first planet carrier and in continuous meshing engagement with both the first sun gear and the first ring gear; and
a second simple planetary gear set having a second sun gear fixedly coupled to the first sun gear, a second planet carrier fixedly coupled to the first ring gear, a second ring gear as the third element, and a second plurality of planet gears supported for rotation relative to the second planet carrier and in continuous meshing engagement with both the second sun gear and the second ring gear.

11. A transmission comprising:
an input shaft;
an output shaft;
a transmission case;
a first gearing arrangement configured to fixedly constrain a first element to rotate at a speed between speeds of the input shaft and a second element;
a second gearing arrangement configured to fixedly constrain a third element to rotate at a speed between speeds of the first element and a fourth element;
a third gearing arrangement configured to fixedly constrain a sixth element to rotate at a speed between speeds of the output shaft and the third element; and
a fourth gearing arrangement configured to fixedly constrain a seventh element to rotate at a speed between speeds of a fifth element and an eighth element wherein the fifth element is coupled to the transmission case, the seventh element is coupled to output shaft, and the eighth element is coupled to the sixth element.

12. The transmission of claim 11 further comprising a first brake configured to selectively couple the fifth element to the transmission case.

13. The transmission of claim 11 further comprising:
a second brake configured to selectively couple the fourth element to the transmission case;
a first clutch configured to selectively operatively couple the input shaft to the second element;
a second clutch configured to selectively couple the input shaft to the sixth element; and
a third clutch configured to selectively couple the fourth element to the sixth element.

14. The transmission of claim 13 further comprising a fourth clutch configured to selectively couple the second element to the third element.

15. The transmission of claim 14 further comprising a third brake configured to selectively couple the second element to the transmission case.

16. The transmission of claim 13 further comprising a third brake configured to selectively couple the second element to the transmission case.

17. A method of operating a vehicle, the method comprising:
in response to selection of high range, launching the vehicle in reverse at a first negative transmission ratio; and
in response to selection of low range, launching the vehicle in reverse at a second negative transmission ratio.

18. The method of claim 17 further comprising shifting from the second negative transmission ratio to the first negative transmission ratio.

19. The method of claim 17 further comprising shifting from the first negative transmission ratio to a third negative transmission ratio.

20. The method of claim 17 further comprising:
in response to selection of high range, launching the vehicle with a first positive transmission ratio; and
in response to selection of low range, launching the vehicle with a second positive transmission ratio and then shifting to the first positive transmission ratio.

21. The method of claim 20 wherein launching the vehicle in low range comprises engaging a range clutch and shifting from the second positive transmission ratio comprises releasing the range clutch.

22. The method of claim 21 further comprising engaging the range clutch to upshift into a third positive transmission ratio.

23. The method of claim 22 wherein the third positive transmission ratio is an overdrive ratio.
